(19) United States
(12) Patent Application Publication
(10) Pub. No.: US 2022/0203815 A1
(43) Pub. Date: Jun. 30, 2022

(54) Electrical Axle Drive for a Vehicle

(71) Applicant: ZF Friedrichshafen AG, Friedrichshafen (DE)

(72) Inventors: Ulrich Kehr, Tettnang (DE); Bernd Vahlensieck, Markdorf (DE)

(21) Appl. No.: 17/606,245

(22) PCT Filed: Mar. 4, 2020
(86) PCT No.: PCT/EP2020/055711

§ 371 Date: Oct. 25, 2021

(30) Foreign Application Priority Data
Apr. 26, 2019 (DE) 10 2019 205 987.2

(51) Int. Cl. B60K 1/00; B60K 17/16

(52) U.S. Cl. CPC B60K 1/00; B60K 2001/001; B60K 17/165

(57) ABSTRACT

An electric axle drive and a vehicle having an electric axle drive are provided. The electric axle drive includes an electric machine (EM) and a differential (10), which couples the electric machine to an axle output. The axle output includes a first output shaft (1) and a second output shaft (2). An axis (B) of the electric machine is arranged at an angle (α) with respect to an axis (A) of the output shafts (1, 2).

### CROSS-REFERENCE TO RELATED APPLICATIONS

The present application is related and has right of priority to German Patent Application No. 102019205987.2 filed in the German Patent Office on Apr. 26, 2019 and is a nationalization of PCT/EP2020/055711 filed in the European Patent Office on Mar. 4, 2020, both of which are incorporated by reference in their entirety for all purposes.

### FIELD OF THE INVENTION

The invention relates generally to an electric axle drive and to a vehicle having an electric axle drive.

### BACKGROUND

Electric axle drives for vehicles, in particular for road vehicles, generally include a single-stage or two-stage transmission, for example, in the form of a spur gear drive, for implementing the ratio between the rotational speed of the electric machine and of the drive output. Known axle drives have a motor axis and an output axis, which are arranged in parallel to each other.

In two-stage transmissions, the distance between the outer diameter of the electric machine and the axis of the output shaft can be set by a shaft, which is referred to as an intermediate shaft. In this way, a sufficiently large distance between the electric machine and the output shaft or drive output can be ensured. This distance is important in order to provide—depending on the structural variant—installation space for the one output shaft or installation space for a shaft joint of the one sideshaft, optionally with associated free-wheeling.

For cost and efficiency reasons, axle drives having only one transmission stage are utilized. This eliminates the degree of freedom, however, to set the distance between the motor and the output axle by the position of the intermediate shaft. An installation-space conflict arises between the electric machine and the output shaft or the shaft joint on the output shaft, which is typically situated next to the electric machine.

In order to be able to arrange an electric machine having a given diameter, the center distance to the output axle must be selected to be appropriately large. Therefore, the diameter of the output spur gear becomes very large. This, in turn, greatly limits the ground clearance of the vehicle.

It is unfavorable to displace the entire drive train in the vehicle upward, since, in this case, the deflection angles of the shaft joints of the sideshafts become larger, which results in losses and a limited service life of the shaft joints. Conversely, the maximally possible diameter of the electric machine is extremely limited when the boundary conditions with respect to ground clearance and necessary distance of the output shaft/shaft joint are observed.

### SUMMARY OF THE INVENTION

Example aspects of the invention provide an improved electric axle drive while observing the aforementioned geometric boundary conditions.

Example aspects of the invention are directed to an electric axle drive for a vehicle, an electric machine, and a differential, which couples the electric machine to an axle output including a first output shaft and a second output shaft.

Example aspects of the invention provide that the axis of the electric machine is arranged at an angle α with respect to the axis of the axle output and/or of the output shafts. Due to the angle, the distance of the motor axis to the output axis is increased. As a result, a larger diameter of the electric machine can be achieved while observing the remaining geometric boundary conditions, and so a greater power can be made available.

The wording “at an angle” means that the axis of the electric machine and the axis of the output shafts are not in parallel to each other, but rather that the axes of the electric machine and the output shafts intersect. The motor axis can be situated in front of, above, or behind the output axis. The motor axis can also be situated askew in relation to the output axis.

It is preferred when the angle is acute. An angle of four degrees (4°), five degrees (5°), six degrees (6°), seven degrees (7°), eight degrees (8°), nine degrees (9°), ten degrees (10°), eleven degrees (11°), twelve degrees (12°), thirteen degrees (13°), fourteen degrees (14°), fifteen degrees (15°), sixteen degrees (16°), seventeen degrees (17°), eighteen degrees (18°), nineteen degrees (19°), twenty degrees (20°), twenty-one degrees (21°), twenty-two degrees (22°), twenty-three degrees (23°), twenty-four degrees (24°), twenty-five degrees (25°), twenty-six degrees (26°), twenty-seven degrees (27°), twenty-eight degrees (28°), twenty-nine degrees (29°), or thirty degrees (30°) has proven to be particularly preferred. Each of these angles or each range of these angles allows for an optimal balance between a maximally possible diameter of the electric machine, on the one hand, and an angle drive that has been optimized with respect to bearing and/or gearing losses, on the other hand.

In order to implement an angle between the axis of the electric machine and the axle output, for example, a bevel gearing, a joint, or a combination of a bevel gear and a joint can be provided.

It is preferred when a drive shaft of the electric machine is rotationally fixed to a gearwheel, for example, in the form of a pinion, which is in mesh with a drive element, for example, in the form of a spur gear of the differential, wherein the meshing of teeth takes place by a bevel gearing. The bevel gearing can take place, for example, with beveloid gears having at least one beveloid gearwheel, or a bevel gear cutting, for example, having two bevel gears. In these gears, the angle can be implemented by the type of meshing. The axis of the gearwheel that is connected to the drive shaft of the electric machine does not need to be aligned in parallel to the axis of the output shaft(s) in this case.

It is preferred when at least one joint is provided, which connects a drive shaft of the electric machine to an intermediate shaft rotationally fixed to a gearwheel, wherein the drive shaft is arranged at an angle with respect to the intermediate shaft, wherein the gearwheel is meshed with a drive element of the differential, wherein the joint is designed for transmitting an angular speed and a torque from the drive shaft to the intermediate shaft arranged at an angle with respect thereto. Here, the axis of the pinion is in parallel to the axis of the drive output. The angle is implemented via a joint.

The selection of the suitable joint depends on the size of the operating angle between the axes and on the rotational speed. The joint can be present, for example, in the form of a constant velocity joint, which allows for a uniform transmission of angular speed and torque in the case of shafts arranged at an angle with respect to one another.

It is preferred when two joints are provided between the gearwheel and the drive shaft, which, in turn, are connected by an intermediate shaft.

It is preferred when the axis of the electric machine and the axis of the axle output are situated in the same plane.

Alternatively to the example arrangement in the same plane, it is preferred when the axis of the electric machine and the axis of the axle output are arranged askew with respect to one another.

According to a second example aspect of the invention, a vehicle having an above-described electric axle drive is provided. The advantages of the electric drive as explained above also extend to the vehicle having a drive train of this type.

A vehicle is preferred, wherein the differential is arranged essentially in the center of the vehicle. In a design of this type, the electric machine is arranged either on the left side or on the right side of the vehicle with regard to the longitudinal axis of the vehicle.

The sideshafts, i.e., the shafts between the output shafts of the differential and the wheels of the vehicle, can be designed to be longer, which, in turn, allows for smaller deflection angles in the shaft joints in the case of an offset of the wheel axle with respect to the differential axle, i.e., the axle of the drive output. The axles can also be designed to be of equal lengths. In this context, one could also speak of a symmetrical arrangement of the differential with respect to the longitudinal axis or with respect to the vehicle.

A vehicle is preferred, wherein the differential is arranged on one of the two sides with respect to a vehicle longitudinal axis (X). An arrangement of this type allows for an even larger electric machine diameter. On the other hand, a design of this type results in a shorter length of the sideshafts and, thereby, to larger deflection angles of the shaft joints.

The invention is not limited to the specified combination of features of the main claim or the claims dependent thereon. In addition, individual features can be combined with one another, provided they arise from the claims, the description of preferred embodiments of the invention which follows, or directly from the drawings. The reference in the claims to the drawings via the use of reference characters is not intended to limit the scope of protection of the claims.

### BRIEF DESCRIPTION OF THE DRAWING

Advantageous example embodiments of the invention, which are explained in the following, are represented in the drawings, in which:

FIGS. 1-4 show preferred example embodiments of an axle drive; and

FIG. 5 shows a vehicle having an axle drive from FIGS. 2 through 4.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

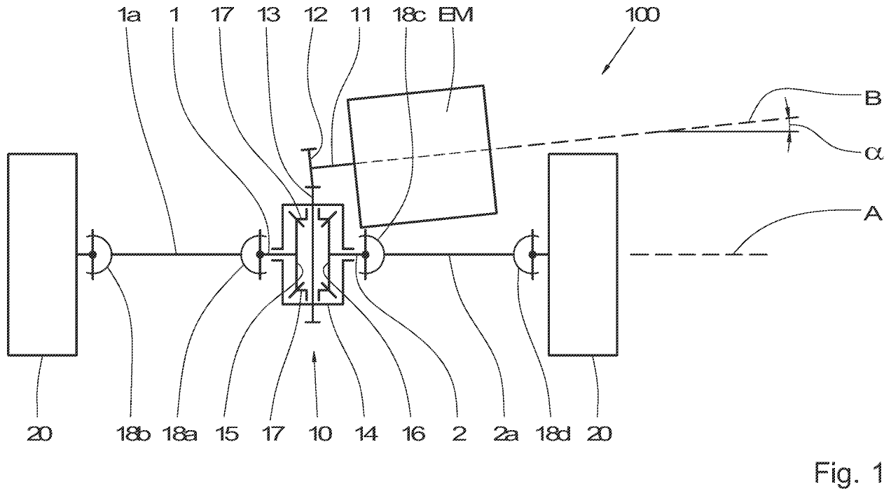

FIG. 1 shows an electric axle drive of a vehicle in a first preferred example embodiment of the invention.

The electric axle drive 100 includes an electric machine EM, an axle output in the form of two output shafts 1, 2, and a differential 10, which couples the electric machine EM to the axle output.

The differential designed as a bevel gear differential 10 has two wheel-side output elements, which are designed as a first output gear 15 and a second output gear 16. The output gears 15, 16 each mesh with a compensating element 17 designed as a spur gear. The compensating elements 17 are mounted in a differential cage 14 so as to be rotatable about respective axes. The first output gear 15 is rotationally fixed to the output shaft 1, which, in turn, is connected via a shaft joint 18a to a first sideshaft 1a. The second output gear 16 is rotationally fixed to the output shaft 2, which, in turn, is connected via a shaft joint 18c to a second sideshaft 2a. A drive element 13 designed as a spur gear is rotationally fixed to the differential cage 14 and can be driven by a gearwheel designed as a bevel gear 12, which is rotationally fixed to a drive shaft 11 of the electric machine.

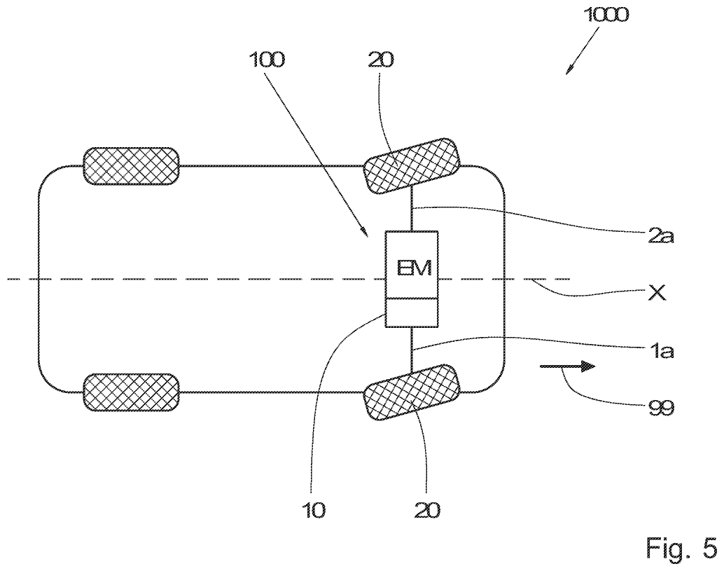

The differential bevel gears 17, which operate between the spur gear 13 and the two output gears 15, 16, can transmit a turning motion from the spur gear 13 to the two output gears 15, 16 and provide a compensatory turning motion between the two output gears 15, 16. During straight-ahead travel 99 of the vehicle 1000 (cf. FIG. 5), the differential bevel gears 17 do not rotate, but rather revolve with the spur gear 13, and so the effect of the differential bevel gears 17 is neutral. During cornering, however, the differential bevel gears 17 rotate in opposition about the respective axes, and so the output gear 15, 16 is driven faster in the outer radius and the other output gear 16, 15 is driven more slowly.

The sideshafts 1a, 2a are connected via shaft joints 18b and 18d, respectively, to wheels 20 of the vehicle. The drive shaft 11 is connected to a rotor (not shown in greater detail) of an electric machine EM, which is the prime mover of the differential.

The axis B of the electric machine EM is situated at an angle α with respect to the output shafts 1, 2. The inclination angle α is between five degrees (5°) and ten degrees (10°) in the present case. In this way, an electric machine EM having a larger diameter than is the case from the prior art can be provided for the axle drive 100. This example embodiment provides for a bevel gearing in the form of beveloid gears having a beveloid gearwheel in order to bring about the angle.

The differential 10 is arranged essentially symmetrically with respect to the lateral distance to the wheels 20, i.e., in the center of the vehicle. The electric machine is therefore situated on one of the two sides with respect to the longitudinal axis X of the vehicle. In the present case, the electric machine is situated to the left, in a direction of travel 99, of the longitudinal axis X. The symmetrical arrangement allows for longer sideshafts and smaller deflection angles in the shaft joints.

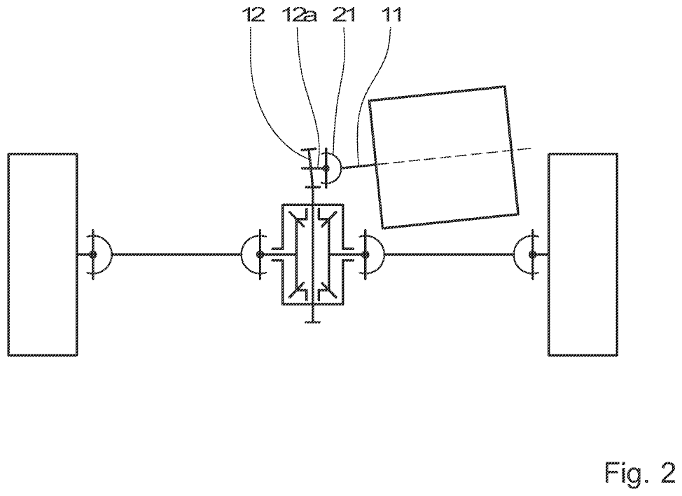

In the example embodiment according to FIG. 2, in contrast to the example embodiment according to FIG. 1, the input shaft 11 of the electric machine EM is coupled via a shaft joint 21 to an intermediate shaft 12a, since the axis of the drive shaft is arranged at an angle with respect to the axis of the intermediate shaft. The intermediate shaft 12a is rotationally fixed to the gearwheel 12. There is no bevel gearing here, but rather an involute gearing. For the rest, this example embodiment corresponds to the example embodiment according to FIG. 2, and so reference is made to the comments presented with respect thereto.

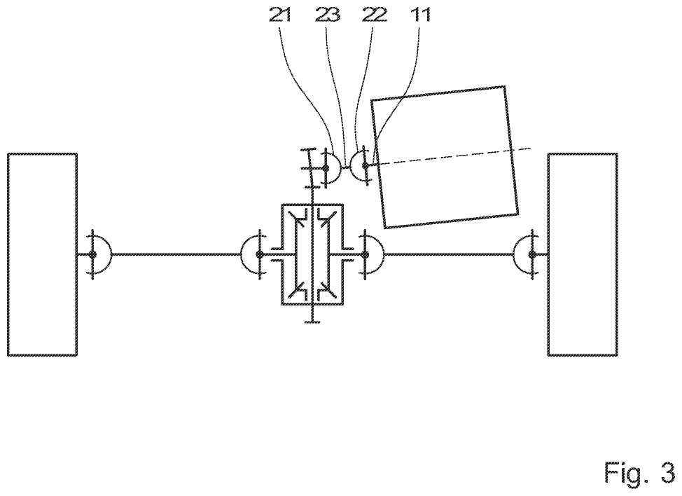

In the example embodiment according to FIG. 3, in contrast to the example embodiment according to FIG. 2, the input shaft 11 of the electric machine EM is connected via two shaft joints 21, 22 to the gearwheel 12. The two joints 21, 22 are connected by an intermediate shaft 23. For the rest, this example embodiment corresponds to the example embodiment according to FIG. 2, and so reference is made to the comments presented with respect thereto.

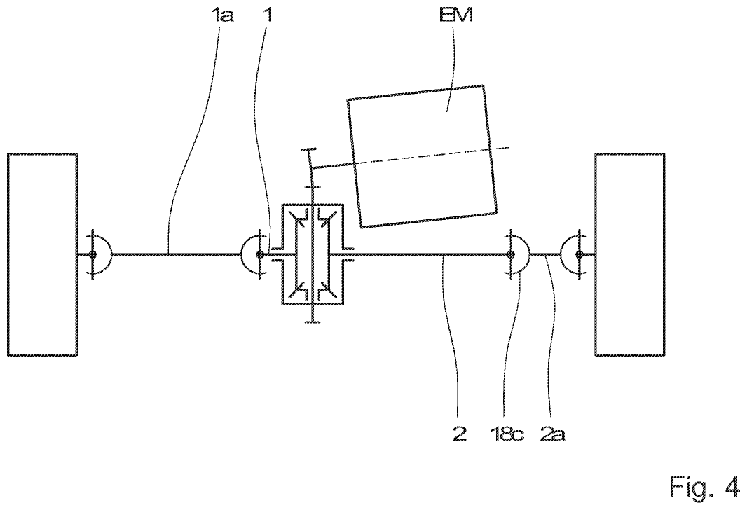

One further preferred example embodiment is represented in FIG. 4. In the example embodiment of FIG. 4, in contrast to the example embodiment according to FIG. 2, the differential 10 is not symmetrically arranged with respect to the distance to the wheels 20. Instead, the differential 10 is arranged on one of the two sides of the vehicle longitudinal axis X, in the present case on the right side in the direction of travel 99. In addition, the output shaft 2, which connects the output gear 16 to the shaft joint 18c, is longer than in the example embodiment according to FIG. 2. In the present example, the output shaft 2 is longer than the length of the electric machine EM. The sideshafts 1a, 2a are designed correspondingly shorter. Due to this asymmetrical arrangement, the diameter of the electric machine EM and, thereby, also the power of the electric machine EM can be increased. The shorter sideshafts result in larger deflection angles of the shaft joints, however.

Finally, FIG. 5 shows a vehicle 1000. The vehicle 1000 can be equipped with each axle drive 100 of the type described in FIGS. 1 through 4. In FIG. 5, the drive train from FIG. 4 arranged symmetrically with respect to the vehicle axis X is shown in diagrammatic form.

The invention was comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit can carry out the functions of several of the units mentioned in the claims. The mere mention of a few measures in multiple various dependent claims is not to be understood to mean that a combination of these measures cannot also be advantageously utilized.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 first output shaft, axle output
1a first sideshaft
2 second output shaft, axle output
2a second sideshaft
10 bevel gear differential
11 drive shaft
12 bevel gear, gearwheel
12a intermediate shaft
13 drive element, spur gear
14 differential cage
15 first output gear
16 second output gear
17 compensating element
18a-d shaft joints
20 wheels
21 shaft joint
22 shaft joint
23 intermediate shaft
EM electric machine
100 electric axle drive
1000 vehicle

1-9: (canceled)

10. An electric axle drive (100) for a vehicle (1000), comprising:
an electric machine (EM);
an axle output including a first output shaft (1) and a second output shaft (2);
a differential (10) coupling the electric machine (EM) to the axle output,
wherein an axis (B) of the electric machine (EM) is arranged at an angle (α) with respect to an axis (A) of the axle output, and
wherein the angle (α) is acute and is no less than four degrees and no greater than thirty degrees.

11. The electric axle drive (100) of claim 10, wherein a drive shaft (11) of the electric machine (EM) is rotationally fixed to a gearwheel (12) in mesh with a drive element (13) of the differential (10), and the meshing of the gearwheel (12) and the drive element (13) of the differential (10) comprises an oblique toothing, a beveloid gear, or a bevel gear cutting configured for forming the angle (α).

12. The electric axle drive (100) of claim 10, wherein:
at least one joint (21) connects a drive shaft (11) of the electric machine (EM) to an intermediate shaft (12a) rotationally fixed to a gearwheel (12), and the drive shaft (11) is arranged at an angle with respect to the intermediate shaft (12a);
the gearwheel (12) is in mesh with a drive element (13) of the differential (10); and
the at least one joint (21) is configured for transmitting an angular speed and a torque from the drive shaft (11) to the intermediate shaft (12a).

13. The electric axle drive (100) of claim 12, wherein two joints (21, 22) are provided between the gearwheel (12) and the drive shaft (11), and the gearwheel (12) and the drive shaft (11) are connected by an additional intermediate shaft (23).

14. The electric axle drive (100) of claim 10, wherein the axis (B) of the electric machine (EM) and the axis (A) of the axle output are situated in a common plane.

15. The electric axle drive (100) of claim 10, wherein the axis (B) of the electric machine (EM) is arranged askew relative to the axis (A) of the axle output.

16. A vehicle (1000), comprising the electric axle drive (100) of claim 10.

17. The vehicle (1000) of claim 16, wherein the differential (10) is arranged essentially in a center of the vehicle.

18. The vehicle (1000) of claim 17, wherein the electric machine (EM) is arranged on one of the two sides with respect to a vehicle longitudinal axis (X).

19. The vehicle (1000) of claim 16, wherein the differential (10) is arranged on one of the two sides with respect to a vehicle longitudinal axis (X).
